(19) United States
(12) Patent Application Publication
(10) Pub. No.: US 2018/0085205 A1
(43) Pub. Date: Mar. 29, 2018

(54) A Negative Pressure Drainage Device Attached to Dental Tissue

(71) Applicants: Na LIU, Beijing (CN); Ning WEN, Beijing (CN); Bin GU, Beijing (CN); Ruijie DANG, Beijing (CN); Bin GUO, Beijing (CN); Lisheng ZHAO, Beijing (CN); Chenqing LIU, Beijing (CN)

(72) Inventors: Na LIU, Beijing (CN); Ning WEN, Beijing (CN); Bin GU, Beijing (CN); Ruijie DANG, Beijing (CN); Bin GUO, Beijing (CN); Lisheng ZHAO, Beijing (CN); Chenqing LIU, Beijing (CN)

(21) Appl. No.: 15/521,005

(22) PCT Filed: Aug. 8, 2016
(86) PCT No.: PCT/CN2016/094011

§ 371 Date: Apr. 21, 2017

(30) Foreign Application Priority Data
Jan. 20, 2016 (CN) 201610035658.5
Jan. 20, 2016 (CN) 201620052150.1
Jan. 20, 2016 (CN) 201620052261.2
Jan. 20, 2016 (CN) 201620052262.7

(51) Int. Cl. A61C 17/06

(52) U.S. Cl. CPC A61C 17/046; A61C 17/0208; A61C 17/043

(57) ABSTRACT

The invention relates to a negative pressure drainage device attached to dental tissue. The negative pressure drainage device has a negative pressure machine, a negative pressure tester, a negative pressure control valve and a sealing part. The negative pressure machine is connected to the negative pressure tester, the negative pressure tester is connected to the negative pressure control valve, and the negative pressure control valve is connected to the sealing part through a connecting part. The device, by using the apical foramina structure of the dental tissues per se, cannot only drain and form negative pressure in the cyst cavity, but also no longer need a long-term implantation of a negative pressure drainage artificial device in the jaw.

### TECHNICAL FIELD

The invention relates to the technical field of medical device, particularly relates to a negative pressure drainage device attached to dental tissue which can be used for clinical treatment of odontogenic non-infectious and infectious diseases, especially for the treatment of diseases such as ameloblastoma, odontogenic jaw cyst, pulpitis, periapical periodontitis, periapical cyst, periapical abscess, periapical granuloma.

### BACKGROUND ART

Nowadays, the method of decompression and drainage has been applied in most of clinical treatments of odontogenic diseases such as ameloblastoma and odontogenic jaw cyst. Moreover, the method of open drainage usually can be applied in the treatment of pulpitis, periapical periodontitis, periapical cyst, periapical abscess and periapical granuloma. Clinical evidence-based medicine and scientific experiments prove that these treatment methods have very good curative effect. Specifically, the decompression, drainage and open drainage aim to provide a channel for local inflammation, which can release pressure to ease pain and local injuries, and reduce the pressure of cyst cavity. After the pressure being eliminated, new bone would form around the diseased areas and cyst cavity can be reduced, thereby preserving the anatomic structures of the jaw and teeth to reduce operation wound and recurrence rate. However, such operations can cause many follow-up problems. For instance, the method of the decompression and drainage applied in the present clinical treatments has a long treatment period, during which the chance of the infection of the cyst cavity may be increased after surgery, and gingival will be prone to grow into the drainage hole to cause a second fenestration operation. Furthermore, the open drainage can bring substances such as oral saliva, food debris, various oral microorganisms and infected tissue to open cavitas pulpae and even periapical tissue, thereby possibly causing more severe secondary inflammation and infection. Therefore, how to shorten the treatment period, reduce the chance of infection and reduce the traumatic treatment has become a hot research topic. Jaw bone, as the most active part of human tissues, can activate osteoclast to cause bone resorption when exposed to pressure, and can activate osteoblast to cause osteogenesis process when exposed to pulling. The operation of negative pressure has a similar principle. The hydrostatic pressure of the periapical inflammation or jaw cyst cavity could change into negative pressure stress, so that the growth factor of the lesion expansion caused by the hydrostatic pressure in the cyst cavity can be eliminated therewith, and the bone tissues would grow into the cyst cavity. Therefore, the course of disease can be shorten and the infection can be reduced at the same time.

### Contents of the Invention

In order to solve the above issues, the present disclosure provides a negative pressure drainage device attached to dental tissue. The device, which combines materials science and biomechanics by using the apical foramina structure of the dental tissues per se, can not only drain and form negative pressure in the cyst cavity, but also no longer need a long-term implantation of a negative pressure drainage artificial device in the jaw. Therefore, the device can greatly shorten the treatment period, reduce the chance of the infection, reduce trauma and intra-oral malaise, improve the clinical curative effect of the treatment of odontogenic-associated diseases, and has achieved a very good effect in practice.

The present disclosure hereby provides the following technical solution.

(1) A negative pressure drainage device attached to dental tissue, wherein the negative pressure drainage device comprises a negative pressure machine, a negative pressure tester, a negative pressure control valve and a sealing part;

the negative pressure machine is connected to the negative pressure tester, the negative pressure tester is connected to the negative pressure control valve, and the negative pressure control valve is connected to the sealing part through a connecting part.

(2) On the basis of the technical solution (1), the negative pressure drainage device further comprises an extracoronal temporary restoration, the sealing part is connected to the extracoronal temporary restoration with a high strength dental adhesive, and the extracoronal temporary restoration is connected to the dental tissue through an adhesive.

(3) On the basis of the technical solution (2), the extracoronal temporary restoration can be prepared in accordance with the requirement for preparing the full crown with a material selected from polymer, metal, metal-ceramic and all-ceramic material. Furthermore, the margin of the extracoronal temporary restoration can be placed supergingivally, evengingivally and subgingivally.

(4) On the basis of the technical solution (2) or (3), depending on the teeth destruction condition or convenient condition, the opening at the oral end of a negative pressure tube can be placed on the occlusal surface, buccal (labial) surface or lingual (palatal) surface of the extracoronal temporary restoration.

(5) On the basis of any of the technical solutions (1) to (4), the sealing part is made of a negative pressure tube and an external layer, the external layer is made of a flexible medical polymer material, and the negative pressure tube is made of a metal material, wherein the external layer is wrapped densely around the negative pressure tube.

(6) On the basis of the technical solution (5), the outside surface of the external layer is a rough surface, and the external layer is set to cylindrical, conical or elliptical shape according to the form of the anterior and posterior cavitas pulpae.

(7) On the basis of the technical solution (5) or (6), the external layer has a diameter of 2 to 10 mm and a height of 2 to 10 mm.

(8) On the basis of any of the technical solutions (5) to (7), said external layer can be grinded and modified according to the form and height of the cavitas pulpae.

(9) On the basis of the technical solution (1), the sealing part is made of the negative pressure tube, a sealing body and a sealing cover, wherein the sealing body and the sealing cover are each made of a flexible medical polymer material, the negative pressure tube is made of a metal material, and the sealing body is wrapped densely around the negative pressure tube.

(10) On the basis of the technical solution (9), the outside surfaces of the sealing body and sealing cover are rough surfaces, and the sealing body and sealing cover are set to cylindrical or elliptical shape according to the form of the anterior and posterior cavitas pulpae or the occlusal surface.

(11) On the basis of the technical solution (9) or (10), the sealing body and sealing cover can be opened and closed repeatedly through a clasp and a slot.

(12) On the basis of the technical solution (9), (10) or (11), the sealing body and the sealing cover have a diameter of 2 to 10 mm and a height of 2 to 10 mm.

(13) On the basis of any of the technical solutions (9) to (12), the sealing body and the sealing cover can be grinded and modified according to the form and height of the cavitas pulpae and teeth surface.

(14) On the basis of the technical solution (13), the grinded and modified scope of the sealing body and the sealing cover is confined to the parts other than the clasp and the slot to avoid the destruction of the clasp and the slot.

(15) On the basis of any of the technical solutions (5) to (14), the negative pressure tube has an internal diameter of 0.5 to 1 mm and a wall thickness of 0.5 to 1 mm. Further, the negative pressure tube has a negative pressure suction hole at the end towards the cavitas pulpae. The negative pressure tube extends out from the external layer for 1 to 10 mm towards the direction of the cavitas pulpae, and the end towards the oral cavity of the negative pressure tube is flush with the external layer and interlinked to the negative pressure control valve via the connecting part.

(16) On the basis of the technical solution (15), the negative pressure tube has an opening at the end towards to the oral cavity, wherein said opening can be open at the side of the lingual (palatal) surface or buccal (labial) surface.

(17) On the basis of any of technical solutions (1) to (16), said negative pressure drainage device further comprises a liquid recovery device and a medicine placing device.

(18) On the basis of any of technical solutions (1) to (17), the liquid recovery device has a volume greater than 0 and less than or equal to 100 μL, and the medicine placing device has a volume of greater than 0 and less than or equal to 100 mm³.

(19) On the basis of any of technical solutions (1) to (18), said sealing part is connected to the dental tissue with a dental adhesive.

(20) On the basis of any of technical solutions (1) to (19), said polymer material is plastic, resin or rubber, and said metal material is medical pure titanium, titanium alloy, cobalt-chromium alloy or stainless steel.

(21) On the basis of any of technical solutions (1) to (20), said negative pressure machine and negative pressure tester can be connected movably to the negative pressure control valve.

(22) On the basis of any of technical solutions (1) to (21), said dental tissue is dental hard tissue.

### Advantageous Effect

The present disclosure has the following advantages: it fills the gaps in the domestic and foreign clinical treatments of odontogenic jaw cyst and periapical lesion to achieve the effect of negative pressure without directly use of the device attached to the dental hard tissue. Therefore, A series of complications caused by the fenestration drainage or the placement of the drainage device by surgery required for the odontogenic jaw cyst, and the open drainage required for the periapical lesion and so on, have been successfully avoided.

The negative pressure drainage device can be directly attached to the diseased tooth to use the natural structure of apical foramina via the negative pressure suction upon the odontogenic related diseases and the drainage of the periapical inflammation under sterile condition by using the negative pressure machine, the negative pressure tester, the negative pressure control valve and the sealing part. Such approach is more advantageous to control infection than the conventional opening drainage method.

By using the liquid recovery device, the drained liquid can be collected and then subject to related detections such as microorganism detection. Furthermore, by using the medicine placing device, antibacterial, oxygen-enriched and coagulative drugs can be released in cavitas pulpae, and the infected substance of the root canal and periapex can be cleaned up.

By using the external temporary restoration, the retention form of the negative pressure suction device can be changed, the indications of the negative pressure drainage device can be expanded, and the opening at the oral end of the negative pressure tube can be set at a convenience location more flexibly.

The sealing body and the sealing cover are connected by the clasp and the slot, in the treatment process can be based on the condition of the illness to open the sealing cover for dental treatment or dressing, which is greatly convenient for clinic.

### DESCRIPTION OF THE DRAWINGS

FIG. 1 is a schematic diagram of the structure according to the first embodiment of the negative pressure drainage device attached to dental tissue provided by the present disclosure.

FIG. 2 is a schematic diagram of the structure according to the second embodiment of the negative pressure drainage device attached to dental tissue provided by the present disclosure.

FIG. 3 is a schematic diagram of the structure according to the third embodiment of the negative pressure drainage device attached to dental tissue provided by the present disclosure.

The reference numerals in the drawings are as follows:

001 is the negative pressure machine, 002 is the negative pressure tester, 003 is negative pressure control valve, 004 is the connecting part, 005 is the external layer of the sealing part, 006 is the negative pressure tube of the sealing part, and 007 is the negative pressure suction hole;

101 is the negative pressure machine, 102 is the negative pressure tester, 103 is negative pressure control valve, 104 is the connecting part, 105 is the external layer of the sealing part, 106 is the negative pressure tube of the sealing part, 107 is the negative pressure suction hole, and 108 is the extracoronal temporary restoration;

201 is the negative pressure machine, 202 is the negative pressure tester, 203 is negative pressure control valve, 204 is the connecting part, 205 is the sealing body of the sealing part, 206 is the negative pressure tube of the sealing part, 207 is the slot of the sealing body, 208 is the sealing cover of the sealing part, and 209 is the clasp of the sealing cover.

### SPECIFIC EMBODIMENTS

Hereinafter, the present invention will be illustrated more detailedly with reference to the figures and the examples. However, the protection scope of the present invention should not be limited to the following examples.

### Example 1

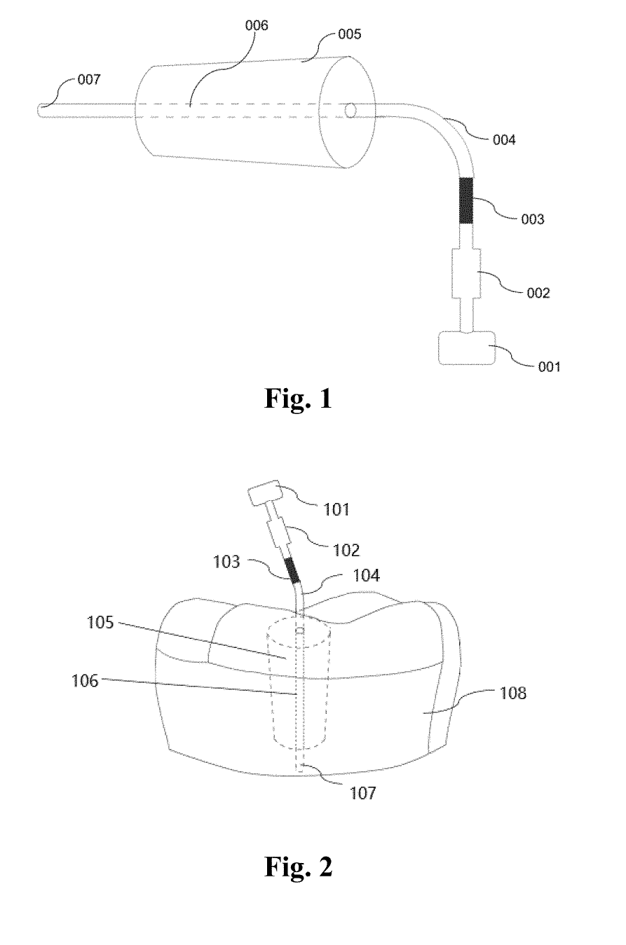

The first embodiment of the negative pressure drainage device attached to dental tissue provided herein was shown in FIG. 1. The negative pressure drainage device attached to dental tissue included: the negative pressure machine 001, the negative pressure tester 002, the negative pressure control valve 003, the sealing part, the liquid recovery device (not shown), the medicine placing device (not shown), wherein the external of the sealing part was the external layer 005 of the sealing part which can be made of a polymer materials such as plastic; the negative pressure tube 006 of the sealing part, which can be made of medical pure titanium or titanium alloy.

Said dental tissue was dental hard tissue. The sealing part was cemented to the dental hard tissue with a dental adhesive.

Size and Preparation

The outside surface of the external layer 005 of the sealing part was a rough surface. According to the different forms of the anterior and posterior cavitas pulpae, the external layer 005 of the sealing part was set to cylindrical or conical shape, and had a diameter of 2 to 10 mm and a height of 2 to 10 mm. The external layer 005 of the sealing part can be grinded and its shape and height can be modified according to the form of the specific cavitas pulpae. The negative pressure tube of the center of the sealing part was wrapped with a polymer material. That is to say, it was wrapped with the external layer 005 of the sealing part, and combined densely with the polymer material. The negative pressure tube had an internal diameter of 0.5 to 1 mm and a thickness of 0.5 to 1 mm. The negative pressure tube of the sealing part had a negative pressure suction hole 007 at the end towards to the cavitas pulpae, and extended out from the polymer materials for 1 to 10 mm towards the direction of the cavitas pulpae. Moreover, the end of the negative pressure tube of the sealing part towards to the end of the oral cavity was flush with the polymer materials, and interlinked to the negative pressure control valve 003 via the connecting part 004. Furthermore, said negative pressure machine and negative pressure tester were connected movably to the negative pressure control valve.

The liquid recovery device had a volume greater than 0 and less than or equal to 100 μL. Moreover, the substances drained under negative pressure can be recovered by the liquid recovery device, and then subject to related detections.

The medicine placing device had a volume of greater than 0 and less than or equal to 100 mm³, and can be used to place oxygen-enriched drugs, antibacterial drugs and coagulative drugs according to different types of inflammation or infection.

### Example 2

The present example differed from Example 1 in that, the external layer 005 of the sealing part was made of a polymer material such as resin and rubber.

### Example 3

The present example differed from Example 1 in that, the external layer 005 of the sealing part was made of a polymer material such as resin, rubber; and the negative pressure tube 006 of the sealing part was made of cobalt-chromium alloy or stainless steel.

### Example 4

This example described a specific method for using the negative pressure drainage device of the examples 1 to 3. The method comprised the following steps: first, according to the treatment site and the diseased teeth to be treated, opening a pulp chamber of the diseased teeth in accordance with the principle of opening pulp chamber to form a smooth and straight channel leading to the root canal and ultimately to the root tip. After thoroughly cleaning and shaping the root canal and routinely disinfecting and drying, setting the liquid drainage device and medicine placing device, and then selecting the sealing parts with different size according to the morphology and size of the root canal and the cavitas pulpae, wherein the sealing part can be polished and adjusted to form a shape consistent with that of the cavitas pulpae. Subsequently, high strength dental adhesive was used to make the sealing part cemented to the dental hard tissue to form a sealed state between the inside and outside parts of the sealing part. After the adhesive solidifying, the negative pressure machine and the negative pressure tester as a whole were connected to the negative pressure control valve and the sealing part with the connecting part, and then sucking the gas inside the sealed part to form a negative pressure environment. According to the type of various diseases, the required negative pressure can be adjusted. Such negative pressure state can drain the exudate apical area, and meanwhile promote the reduction of the apical cyst cavity and accelerate the osteogenesis.

The negative pressure drainage device of the invention has the following advantages: 1. there is a sustained negative pressure and relatively sterile environment in the root canal; 2. the drained substances can be expediently detected; 3. different drugs can be placed conveniently and flexibly according to the different types of treatment; 4. the attachment site can be the cavitas pulpae so that the device is especially suitable for the negative pressure drainage of the dental pulp and the periapical inflammation; 5. the device can promote the reduction of the apical cyst cavity and accelerate the osteogenesis around the cyst cavity; 6. fewer traumas can be achieved.

### Example 5

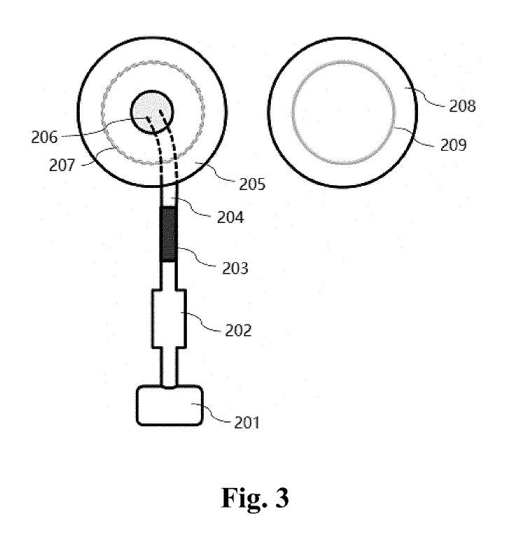

The second embodiment of the negative pressure drainage device attached to dental tissue provided herein was shown in FIG. 2. The negative pressure drainage device attached to dental tissue included the negative pressure machine 101, the negative pressure tester 102, the negative pressure control valve 103, the sealing part, the extracoronal temporary restoration 108, liquid recovery device (not shown), medicine placing device (not shown), wherein the external of the sealing part was the external layer 105, which can be made of polymer materials such as plastic; the center of the sealing part was the negative pressure tube 106, which can be made of medical pure titanium and titanium alloy.

Size and Preparation

The outside surface of the external layer of the sealing part was a rough surface. According to the different forms of the anterior and posterior cavitas pulpae, the external layer of the sealing part was set to cylindrical or square-round shape, and had a diameter of 2 to 10 mm and a height of 2 to 10 mm. The external layer of the sealing part can be grinded and its shape and height can be modified according to the form of the specific cavitas pulpae. The negative pressure tube of the center of the sealing part was wrapped with a polymer material. That is to say, it was wrapped with the external layer, and combined densely with the polymer material. The negative pressure tube had an internal diameter of 0.5 to 1 mm and a thickness of 0.5 to 1 mm. The negative pressure tube of the sealing part had a negative pressure suction hole 107 at the end towards to the cavitas pulpae, and extended out from the polymer materials for 1 to 10 mm towards the direction of the cavitas pulpae. Moreover, the end of the negative pressure tube of the sealing part towards to the end of the oral cavity was flush with the polymer materials, and interlinked to the negative pressure control valve 103 via the connecting part 104. Furthermore, said negative pressure machine and negative pressure tester were connected movably to the negative pressure control valve.

The extracoronal temporary restoration can be prepared in accordance with the requirement for preparing the full crown with a material selected from polymer, metal, metal-ceramic and all-ceramic material. Furthermore, the margin of the extracoronal temporary restoration can be placed supergingivally, evengingivally and subgingivally.

Depending on the teeth destruction condition or convenient condition, the opening at the oral end of a negative pressure tube can be placed on the occlusal surface, buccal (labial) surface or lingual (palatal) surface of the extracoronal temporary restoration.

The liquid recovery device has a volume greater than 0 and less than or equal to 100 μL. Moreover, the substances drained under negative pressure can be recovered by the liquid recovery device, and then subject to related detections.

The medicine placing device had a volume of greater than 0 and less than or equal to 100 mm³, and can be used to place oxygen-enriched drugs, antibacterial drugs and coagulative drugs according to different types of inflammation or infection.

### Example 6

The present example differed from Example 5 in that, the external layer 105 of the sealing part was made of a polymer material such as resin and rubber.

### Example 7

The present example differed from Example 5 in that, the external layer 105 of the sealing part was made of a polymer material such as resin, rubber; and the negative pressure tube 106 of the sealing part was made of cobalt-chromium alloy or stainless steel.

### Example 8

This example described a specific method for using the negative pressure drainage device of the examples 5 to 7. The method comprised the following steps: first, according to the treatment site and the diseased teeth to be treated, opening a pulp chamber of the diseased teeth in accordance with the principle of opening pulp chamber to form a smooth and straight channel leading to the root canal and ultimately to the root tip. The extracoronal temporary restoration was prepared according to the principle of the dental preparation. A port with the sealing part was reserved on the extracoronal temporary restoration, which was then adhered to the dental hard tissue. After thoroughly cleaning and shaping the root canal and routinely disinfecting and drying, setting the liquid drainage device and medicine placing device, and then selecting the sealing parts with different size according to the morphology and size of the root canal and the cavitas pulpae, wherein the sealing part can be polished and adjusted to form a shape consistent with that of the cavitas pulpae. Subsequently, dental adhesive was used to make the sealing part cemented to the extracoronal temporary restoration to form a sealed state between the inside and outside parts of the sealing part. After the adhesive solidifying, the negative pressure machine and the negative pressure tester as a whole were connected to the negative pressure control valve and the sealing part with the connecting part, and then sucking the gas inside the sealed part to form a negative pressure environment. According to the type of various diseases, the required negative pressure can be adjusted. Such negative pressure state can drain the exudate apical area, and meanwhile promote the reduction of the apical cyst cavity and accelerate the osteogenesis.

The negative pressure drainage device of the invention has the following advantages: 1. there is a sustained negative pressure and relatively sterile environment in the root canal; 2. the drained substances can be expediently detected; 3. different drugs can be placed conveniently and flexibly according to the different types of treatment; 4. the attachment site can be the cavitas pulpae so that the device is especially suitable for the negative pressure drainage of the dental pulp and the periapical inflammation; 5. the device can promote the reduction of the apical cyst cavity and accelerate the osteogenesis around the cyst cavity; 6. fewer traumas can be achieved.

### Example 9

The third embodiment of the negative pressure drainage device attached to dental tissue provided herein was shown in FIG. 3. The negative pressure drainage device attached to dental tissue included: the negative pressure machine 201, the negative pressure tester 202, the negative pressure control valve 203, the sealing part, the liquid recovery device (not shown), the medicine placing device (not shown). The sealing part was made of the negative pressure tube 206, the sealing body 205 and the sealing cover 208, wherein the sealing body 205 and the sealing cover 208 can be made of a polymer material such as plastic. The negative pressure tube 206 inside the sealing part can be made of medical pure titanium or titanium alloy. The negative pressure tube had an opening towards to the oral cavity, wherein said opening can be opened at the side of the lingual (palatal) surface or buccal (labial) surface. One of the clasp 209 and the slot 207 was set on the sealing body and the other was set on the sealing cover. The sealing body and sealing cover could be opened and closed repeatedly through the clasp 209 and the slot 207.

Said dental tissue is dental hard tissue. The sealing part was connected to the dental hard tissue with a dental adhesive.

Size and Preparation

The outside surface of the sealing part was a rough surface. According to the different forms of the anterior and posterior cavitas pulpae, the sealing part was set to circular or elliptical shape, and had a diameter of 2 to 10 mm and a height of 1 to 2 mm. The sealing part can be grinded and its shape and height can be modified according to the form of the specific cavitas pulpae. The grinded and modified scope of the sealing body and the sealing cover was confined to the parts other than the clasp and the slot to avoid the destruction of them. The negative pressure tube inside the sealing part was wrapped with a polymer material and combined densely with the polymer material. The negative pressure tube had an internal diameter of 0.5 to 1 mm and a thickness of 0.5 to 1 mm. The negative pressure tube had a negative pressure suction hole at the end towards to the cavitas pulpae, and extended out from the polymer materials for 1 to 10 mm towards the direction of the cavitas pulpae. Moreover, the end of the negative pressure tube towards to the end of the oral cavity was flush with the polymer materials, and interlinked to the negative pressure control valve via the connecting part. Furthermore, said negative pressure machine and negative pressure tester were connected movably to the negative pressure control valve.

The liquid recovery device had a volume greater than 0 and less than or equal to 100 μL. Moreover, the substances drained under negative pressure can be recovered by the liquid recovery device, and then subject to related detections.

The medicine placing device had a volume of greater than 0 and less than or equal to 100 mm³, and can be used to place oxygen-enriched drugs, antibacterial drugs and coagulative drugs according to different types of inflammation or infection.

### Example 10

The present example differed from Example 9 in that, the external layer 205 of the sealing part was made of a polymer material such as resin and rubber.

### Example 11

The present example differed from Example 9 in that, the external layer 205 of the sealing part was made of a polymer material such as resin, rubber; and the negative pressure tube 206 of the sealing part was made of cobalt-chromium alloy or stainless steel.

### Example 12

This example described a specific method for using the negative pressure drainage device of the examples 9 to 11. The method comprised the following steps: first, according to the treatment site and the diseased teeth to be treated, opening a pulp chamber of the diseased teeth in accordance with the principle of opening pulp chamber to form a smooth and straight channel leading to the root canal and ultimately to the root tip. After thoroughly cleaning and shaping the root canal and routinely disinfecting and drying, setting the liquid drainage device and medicine placing device, and then selecting the sealing parts with different size according to the morphology and size of the root canal and the occlusal surface, wherein the sealing part can be polished and adjusted to form a shape consistent with that of the cavitas pulpae and the occlusal surface. Subsequently, dental adhesive was used to make the sealing body cemented to the dental hard tissue, and the sealing cover was combined to the sealing body with the clasp and the slot, thereby forming a sealed state between the inside and outside parts of the sealing part. After the adhesive solidifying, the negative pressure machine and the negative pressure tester as a whole were connected to the negative pressure control valve and the sealing part with the connecting part, and then sucking the gas inside the sealed part to form a negative pressure environment. According to the type of various diseases, the required negative pressure can be adjusted. Such negative pressure state can drain the exudate apical area, and meanwhile promote the reduction of the apical cyst cavity and accelerate the osteogenesis.

The negative pressure drainage device of the invention has the following advantages: 1. there is a sustained negative pressure and relatively sterile environment in the root canal; 2. the drained substances can be expediently detected; 3. different drugs can be placed conveniently and flexibly according to the different types of treatment; 4. the attachment site can be the cavitas pulpae so that the device is especially suitable for the negative pressure drainage of the dental pulp and the periapical inflammation; 5. the device can promote the reduction of the apical cyst cavity and accelerate the osteogenesis around the cyst cavity; 6. fewer traumas can be achieved. The above content is a further and detailed description of the present invention, which cannot be interpreted as a limitation to the embodiments according to the invention. Various changes and modifications could be made by a person skilled in the art without departing from the spirit and scope of the invention described herein. For instance, the external layer of the sealing part can be designed into a polygonal shape, and the negative pressure tube of the sealing part can be prepared with a rigid plastic. The appending claims are intended to cover such modifications as would fall within the true scope and spirit of the present invention.

1. A negative pressure drainage device attached to dental tissue, wherein the negative pressure drainage device comprises a negative pressure machine, a negative pressure tester, a negative pressure control valve and a sealing part;
the negative pressure machine is connected to the negative pressure tester, the negative pressure tester is connected to the negative pressure control valve, and the negative pressure control valve is connected to the sealing part through a connecting part.

2. The device according to claim 1, wherein the negative pressure drainage device further comprises an extracoronal temporary restoration, the sealing part is connected to the extracoronal temporary restoration with a high strength dental adhesive, and the extracoronal temporary restoration is connected to the dental tissue through an adhesive;
preferably, the extracoronal temporary restoration can be prepared in accordance with the requirement for preparing the full crown with a material selected from polymer, metal, metal-ceramic and all-ceramic material. Furthermore, the margin of the extracoronal temporary restoration can be placed supergingivally, evengingivally and subgingivally;
preferably, depending on the teeth destruction condition or convenient condition, the opening at the oral end of a negative pressure tube can be placed on the occlusal surface, buccal (labial) surface or lingual (palatal) surface of the extracoronal temporary restoration.

3. The device according to claim 1, wherein the sealing part is made of a negative pressure tube and an external layer, the external layer is made of a flexible medical polymer material, and the negative pressure tube is made of a metal material, wherein the external layer is wrapped densely around the negative pressure tube.

4. The device according to claim 3, wherein the outside surface of the external layer is a rough surface, and the external layer is set to cylindrical, conical or elliptical shape according to the form of the anterior and posterior cavitas pulpae;
preferably, the external layer has a diameter of 2 to 10 mm and a height of 2 to 10 mm;
preferably, said external layer can be grinded and modified according to the form and height of the cavitas pulpae.

5. The device according to claim 1, wherein the sealing part is made of the negative pressure tube, a sealing body and a sealing cover, wherein the sealing body and the sealing cover are each made of a flexible medical polymer material, the negative pressure tube is made of a metal material, and the sealing body is wrapped densely around the negative pressure tube.

6. The device according to claim 5, wherein the outside surfaces of the sealing body and sealing cover are rough surfaces, and the sealing body and sealing cover are set to cylindrical, elliptical or polygonal shape according to the form of the anterior and posterior cavitas pulpae or the occlusal surface;
preferably, the sealing body and sealing cover can be opened and closed repeatedly through a clasp and a slot;
preferably, the sealing body and the sealing cover have a diameter of 2 to 10 mm and a height of 2 to 10 mm;
preferably, the sealing body and sealing cover can be grinded and modified according to the form and height of the cavitas pulpae and teeth surface;
more preferably, the grinded and modified scope of the sealing body and the sealing cover is confined to the parts other than the clasp and the slot to avoid the destruction of the clasp and the slot.

7. The device according to claim 3, wherein the negative pressure tube has an internal diameter of 0.5 to 1 mm and a wall thickness of 0.5 to 1 mm; the negative pressure tube has a negative pressure suction hole at the end towards the cavitas pulpae; the negative pressure tube extends out from the external layer for 1 to 10 mm towards the direction of the cavitas pulpae; the end towards the oral cavity of the negative pressure tube is flush with the external layer, and interlinked to the negative pressure control valve via the connecting part;
preferably, the negative pressure tube has an opening at the end towards to the oral cavity, wherein said opening can be opened at the side of the lingual (palatal) surface or buccal (labial) surface.

8. The device according to claim 1, wherein said negative pressure drainage device further comprises a liquid recovery device and a medicine placing device;
preferably, the liquid recovery device has a volume greater than 0 and less than or equal to 100 μL, and the medicine placing device has a volume of greater than 0 and less than or equal to 100 mm³.

9. The device according to claim 1, wherein said sealing part is connected to the dental tissue with a dental adhesive;
preferably, said polymer material is plastic, resin or rubber, and said metal material is medical pure titanium, titanium alloy, cobalt-chromium alloy or stainless steel;
preferably, said negative pressure machine and negative pressure tester can be connected movably to the negative pressure control valve;
preferably, said dental tissue is dental hard tissue.

10. The device according to claim 5, wherein the negative pressure tube has an internal diameter of 0.5 to 1 mm and a wall thickness of 0.5 to 1 mm; the negative pressure tube has a negative pressure suction hole at the end towards the cavitas pulpae; the negative pressure tube extends out from the external layer for 1 to 10 mm towards the direction of the cavitas pulpae; the end towards the oral cavity of the negative pressure tube is flush with the external layer, and interlinked to the negative pressure control valve via the connecting part;
preferably, the negative pressure tube has an opening at the end towards to the oral cavity, wherein said opening can be opened at the side of the lingual (palatal) surface or buccal (labial) surface.
